(19) United States
(12) Patent Application Publication
(10) Pub. No.: US 2015/0345280 A1
(43) Pub. Date: Dec. 3, 2015

(54) POLISHED ROD-MOUNTED PUMP CONTROL APPARATUS

(71) Applicant: SCHNEIDER ELECTRIC USA, INC., Palatine, IL (US)

(72) Inventor: Alan Frederick Krauss, Raleigh, NC (US)

(21) Appl. No.: 14/654,032

(22) PCT Filed: Dec. 20, 2012
(86) PCT No.: PCT/US12/70978

§ 371 Date: Jun. 19, 2015

(51) Int. Cl. E21B 44/00; E21B 47/00; G05B 15/02; E21B 43/12

(52) U.S. Cl. CPC E21B 44/005; E21B 43/121; E21B 47/0007; G05B 15/02

(57) ABSTRACT

A method and apparatus for controlling a pump configured to pump liquid out of a well is described. A compact sensor package including a force sensor, position sensor, PLC, and transmitter may be disposed at a single location of the pump and communicate with a pump controller.

### BACKGROUND OF THE DISCLOSURE

1. Field of the Disclosure

Oil and natural gas are often extracted from a well in the ground with reciprocating pumps referred to as “horse head pumps” or pumpjacks. It is sometimes desirable to control the speed of a pumpjack responsive to whether the well that the pumpjack is pumping oil or gas from is producing to reduce power consumed by the to pumpjack. Aspects and embodiments of the present disclosure are directed generally to methods and apparatus for controlling the operation of oil and gas pumpjack systems.

2. Discussion of Related Art

As disclosed in co-pending U.S. patent application Ser. No. 13/114,508 “PUMPJACK PRODUCTION CONTROL,” filed May 24, 2011, which is incorporated herein in its entirety for all purposes, pumpjack systems often include a pump-off controller that switches a pump between an ON state and an OFF state based on how long the pump has been in a particular state. These pump-off controllers may also switch the pump to the OFF state when a pump-off condition is detected, such as an underfilled pump stroke. In some systems, the well is intended for producing gas, and the pump is used to remove largely undesirable liquid from the well (to make room for the gas to enter the well for extraction). In these types of wells, the pump may run regardless of whether liquid extraction at a given time is beneficial to gas production.

As also disclosed in co-pending U.S. patent application Ser. No. 13/114,508, the state of the pump may be controlled based on feedback information regarding the rate of a product being produced by the well. For example, where gas (for example, natural gas) is being produced by the well, the pump may be switched between the ON state and the OFF state depending on whether the production rate is determined to be increasing, decreasing, or steady. The switching of the pump from the OFF state to the ON state may also be based on a parallel decision based on whether a pump off condition has been reached. Moreover, the pump off time may be adjusted based on the determined production rate.

### SUMMARY OF THE DISCLOSURE

The apparatus and techniques described herein may be utilized in connection with various types of pump systems, such as, but not limited to, a pumpjack system for pumping water and liquid oil, and for producing natural gas from a well.

In accordance with an aspect of the present disclosure there is provided an to integrated sensor and control component package for control of a pumpjack. The integrated sensor and control component package comprises a force sensor contained in a package, a position sensor contained in the package, and a data transmitter contained in the package and coupled to the force sensor and the position sensor and configured to transmit control signals for the pumpjack to one of a controller and a prime mover of the pumpjack.

In accordance with some embodiments the integrated sensor and control component package further comprises a signal conditioner contained in the package, the signal conditioner coupled to one of the force sensor and the position sensor and configured to process a signal from one of the force sensor and the position sensor.

In accordance with some embodiments the integrated sensor and control component package further comprises a data processor contained in the package, the data processor coupled to the signal conditioner and the data transmitter and configured to receive and process data from the signal conditioner and to provide an output signal to the data transmitter.

In accordance with some embodiments the integrated sensor and control component package further comprises a power source contained in the package, the power source coupled to one or more of the force sensor, position sensor, signal conditioner, data processor, and data transmitter and configured to supply power to one or more of the force sensor, position sensor, signal conditioner, data processor, and data transmitter.

In accordance with some embodiments the power source is configured to convert kinetic energy to electrical energy.

In accordance with some embodiments the power source comprises a battery.

In accordance with some embodiments the data transmitter is configured to communicate wirelessly with the one of the controller and the prime mover of the pumpjack

In accordance with some embodiments the data transmitter is configured to communicate commands to the one of the controller and the prime mover to one or more of stop the pumpjack, start the pumpjack, and adjust a pumping speed of the pumpjack.

In accordance with some embodiments the force sensor comprises a load cell. In accordance with some embodiments the force sensor comprises a strain gauge.

In accordance with an aspect of the present disclosure there is provided a method of controlling a pumpjack including a walking beam, polished rod, and a controller. The method comprises generating a force signal indicative of a force applied to the polished rod with a force sensor contained in a package, generating a position signal indicative of a position of the polished rod with a position sensor contained in the package, generating a control signal for the pumpjack responsive to a value of one of the force signal and the position signal, and transmitting the control signal to the controller from a data transmitter contained in the package.

In accordance with some embodiments the method further comprises processing one of the force signal and the position signal with a signal conditioner contained in the package prior to generating the control signal for the pumpjack. In accordance with some embodiments generating the control signal comprises processing one of the force signal and the position signal with a data processor contained in the package.

In accordance with some embodiments the method further comprises supplying power to one or more of the force sensor, position sensor, signal conditioner, data processor, and data transmitter from a power source contained in the package.

In accordance with some embodiments generating the control signal for the pumpjack comprises generating the control signal responsive to a combination of the value of the force signal and the value of the position signal.

In accordance with some embodiments transmitting the control signal to the controller from the data transmitter comprises wirelessly transmitting the control signal to the controller from the data transmitter.

In accordance with some embodiments transmitting the control signal to the controller from the data transmitter comprises transmitting a signal commanding the controller to one of stop the pumpjack, start the pumpjack, and adjust a pumping to speed of the pumpjack.

In accordance with some embodiments generating the force signal comprises generating a signal indicative of a compressive force applied to a load cell coupled to the polished rod.

In accordance with some embodiments generating the force signal comprises generating a signal indicative of a degree of flexure of the walking beam.

In accordance with an aspect of the present disclosure there is provided a method of retrofitting a pumpjack. The method comprises providing the pumpjack with an integrated sensor and control component package including a force sensor contained in a package, a position sensor contained in the package, and a data transmitter contained in the package and coupled to the force sensor and the position sensor and configured to transmit control signals for the pumpjack to one of a controller and a prime mover of the pumpjack.

These and other aspects of the disclosure will be apparent upon consideration of the following detailed description.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a cross-sectional view of an example pumpjack system;

FIG. 2 is a cross-sectional view of an example downhole pump in operation during an up stroke;

FIG. 3 is a cross-sectional view of an example downhole pump in operation during a down stroke;

FIG. 4 is a block diagram of an example controller that may be used to perform various functions;

FIG. 5 is another block diagram of an example controller, including a pump off controller and a production controller;

FIG. 6 is a schematic diagram of an upper portion of a polished rod assembly of an example pumpjack system;

FIG. 7 a schematic diagram of a portion of a walking beam of an example pumpjack system;

FIG. 8 is a schematic diagram of an upper portion of a polished rod assembly of another example pumpjack system;

FIG. 9 a schematic diagram of a portion of a walking beam of another example pumpjack system; and

FIG. 10 is a block diagram of an integrated sensor and control component package for a pumpj ack.

### DETAILED DESCRIPTION OF THE DISCLOSURE

This disclosure is not limited in its application to the details of construction and the arrangement of components set forth in the following description or illustrated in the drawings. The methods and apparatus disclosed herein are capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

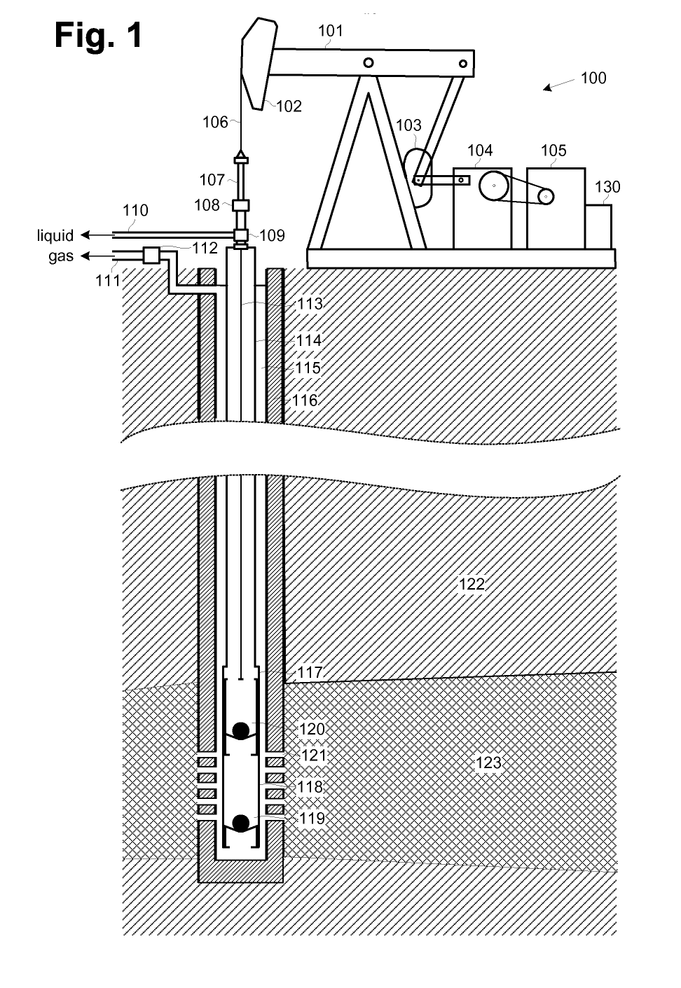

FIG. 1 is a cross-sectional view of an example pumpjack system 100. Such a system 100 may include an above-ground structure that includes a walking beam 101 onto which a horse head 102 is mounted. Walking beam 101 may reciprocate so as to move horse head 102 upward (up stroke) and downward (down stroke) on a periodic basis. To move walking beam 101, a controller 130 may command a prime mover 105 (such as a motor) to send rotational power to a transmission 104, which may include a gear reducer that causes a crank arm and counter weight 103 to rotate at a reduced rotational speed and increased torque relative to prime mover 105. Because the point of attachment is offset from the point of rotational axis, this causes an arm (often referred to as a Pitman arm) attached to walking beam 101 to move walking beam 101 in a reciprocating manner.

As horse head 102 moves up and down, this causes a string 106 (also known to as a birdie) that is usually made of a steel cable to also move up and down. In turn, this movement causes a polished rod 107 to move up and down through a lubricated stuffing box 108, which in turn causes a sucker rod 113 (typically made of a series of longitudinally interconnected steel rods) attached to the lower end of polished rod 107 to also move up and down.

Sucker rod 113 extends downward into a well in ground 122, through tubing 114 to a downhole pump 117. A hollow annular region, referred to herein as annulus 115, encircles tubing 114 and is disposed between tubing 114 and an outer casing 116. Casing 116 includes a series of perforations 121 that expose annulus 115 to an oil or gas bearing region 123 of ground 122. Liquids, such as oil and water, and gases, such as hydrocarbon gases (for example, methane, ethane, etc.) enter perforations 121 into annulus 115 through a combination of outside pressure and a vacuum produced by downhole pump 117. Liquids fall to the bottom of annulus 115 due to gravity, and gases (being lighter than the liquids) rise upward in annulus 115.

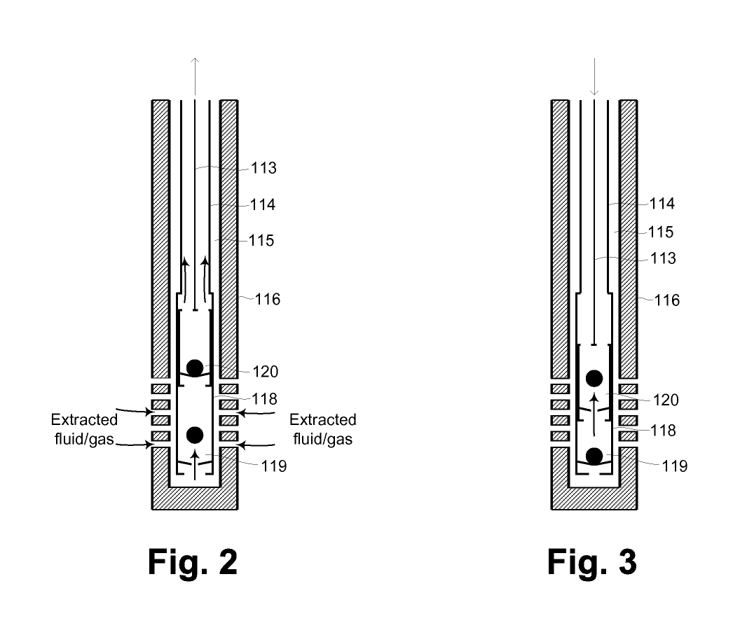

Downhole pump 117 may include a standing valve 119, a travelling valve 120 coupled to sucker rod 113, and a hollow region referred to as a pump barrel 118 disposed between the standing and travelling valves 119, 120. Downhole pump 117 typically operates as follows. Referring to FIG. 2, as sucker rod 113 moves in an up stroke, liquid above travelling valve 120 causes travelling valve 120 to close, and so the upward movement creating a vacuum between travelling valve 120 and standing valve 119. This causes standing valve 119 to open, allowing liquid that has accumulated at the bottom of annulus 115 to be drawn up through standing valve 119. Meanwhile, if tubing 114 is sufficiently already full of previously pumped liquids, then the liquid at the top of the liquid stack in tubing 114 is pushed upward an outward through a junction 109 and an exit tube 110 for collection and/or disposal.

On the down stroke (FIG. 3), sucker rod 113 moves downward, also causing travelling valve 120 to move downward. This produces a relatively higher pressure between travelling valve 120 and standing valve 119, causing it to open and travel downward through the liquid that previously passed through standing valve 119 on the up stroke. The higher pressure also causes standing valve 119 to close, thereby forcing the previously-drawn liquid to remain in place while travelling valve 120 to moves downward through that liquid. By alternating up and down strokes, downhole pump 117 may therefore draw liquids that have fallen to the bottom of annulus 115 up and out of the well.

As previously explained, while liquids fall to the bottom of annulus 115, gases tend to rise upward in annulus 115. Thus, depending upon the level of the liquid at the bottom of annulus 115 relative to the intake of downhole pump 117, gases are ideally not pumped through downhole pump 117. Instead, gases may be collected and/or disposed of from the well through an exit tube 111 disposed at or near the top of annulus 115. A measurement device 112 may be coupled to exit tube 111 for measuring the volume and/or rate of the gas traveling through exit tube 111.

Depending upon the desired product to be produced by the well, either the gas, or the liquid, or both the gas and the liquid may be considered a production product. Likewise, depending upon what is desired, the gas or the liquid may be considered a waste product. For example, depending upon where the well is located, the well may produce an excellent supply of oil, whereas the gas also produced may be an unwanted byproduct or it may be a useful product. In this case, downhole pump 117 may be used to pump the desirable oil (along with other liquids such as water). Or, where gas is considered the main product to be produced by the well, such as where the well is located in a region that contains little to no liquid petroleum product to be extracted, then the waste liquid may primarily include water (with various contaminants). In this case, the downhole pump 117 may be used to draw up the waste liquid simply to prevent annulus 115 from becoming full of the liquid and thereby preventing the desirable gas product from entering annulus 115.

Pumpjack system 100 may operate continuously or on a periodic basis, under the control of controller 130. For example, controller 130 may cause prime mover 105 to continuously run so as to cause pumpjack system 100 to perform a series of stroke cycles (each stroke cycle including a pair of an upstroke and a downstroke). Such continuous operation may carry on until a pump off condition occurs. A pump off condition may occur where, for instance, it is determined that there is insufficient liquid in annulus 115 to be pumped by downhole pump 117. Continuing to pump to under such a condition may result in conditions that can cause damage to the pumpjack system 100. A pump off condition may also occur due to a timeout. For instance, controller 130 may be configured so as to continuously cause pumpjack system 100 to pump for X amount of time or until another pump off condition is met, whichever occurs first. In other examples, pumpjack system 100 may be controlled to perform only a single stroke cycle at a time, with a delay between cycles. In still further examples, pumpjack system 100 may be controlled to adjust the speed of a stroke. The stroke speed, continuous duration, stroke frequency, and/or delay between stroke cycles may be set so as to, ideally, minimize energy expended, minimize pumpjack system wear, and maximize production. All of these can depend upon a variety of factors. For example, if liquid is drawn through perforations 121 into annulus 115 very quickly and easily, then pumpjack system 100 may need to operate downhole pump 117 more often or on a more continuous basis. Otherwise, the liquid level in annulus 115 may rise too high, reducing the efficiency of the system especially where gas is the desired product (since there will be less room in annulus 115 for the gas). On the other hand, if liquid is not drawn quickly through perforations 121, then the liquid level may be too low in annulus 115 unless pumping is reduced. As discussed above, this may allow gas to be pumped up through downhole pump 117, potentially causing production loss, gas lock and/or equipment damage.

As can be seen, there is accordingly a level, or range of levels, at which the liquid level in annulus 115 should be maintained to provide a desired system efficiency. In an ideal world, one might directly measure the liquid level and control pumpjack system 100 based on the direct measurement. While such an arrangement has been proposed, this is not always practical, because downhole pump 117 may be located extremely deep into the earth and subject to intense environmental conditions, making the sensor, and maintenance thereof, expensive. Moreover, such an arrangement would involve finding a way for the remote underground sensor to communicate with the above-ground control system, thereby raising an additional challenge.

Another way to control a pumpjack is to measure the mechanical force to experienced by certain system components over the duration of an upstroke and/or a downstroke. Force may be measured in a variety of ways, such as using a conventional downhole card inside the well and/or a dynamometer coupled to an above-ground portion of the pumpjack system. When the measured force is graphed against the displacement of the travelling valve of the downhole pump (or against the displacement of any other reciprocating or rotating portion of the pumpjack), such a graph results in a curve that is known to provide useful information about the conditions experienced by the downhole pump.

Another way to control a pumpjack is to measure the torque experienced by a component of the pumpjack such as the prime mover 105. Torque may be measured in a variety of ways, such as using an ammeter on current fed to a prime mover 105 (if prime mover 105 is an electric motor). When the measured torque is graphed against the displacement of a reciprocating component of the pumpjack system such as the reciprocating polished rod 107, such a graph results also in a curve that is known to provide information that may be used to estimate various conditions experienced by the pumpjack system 100, such as pump fill and/or whether a pump-off condition exists.

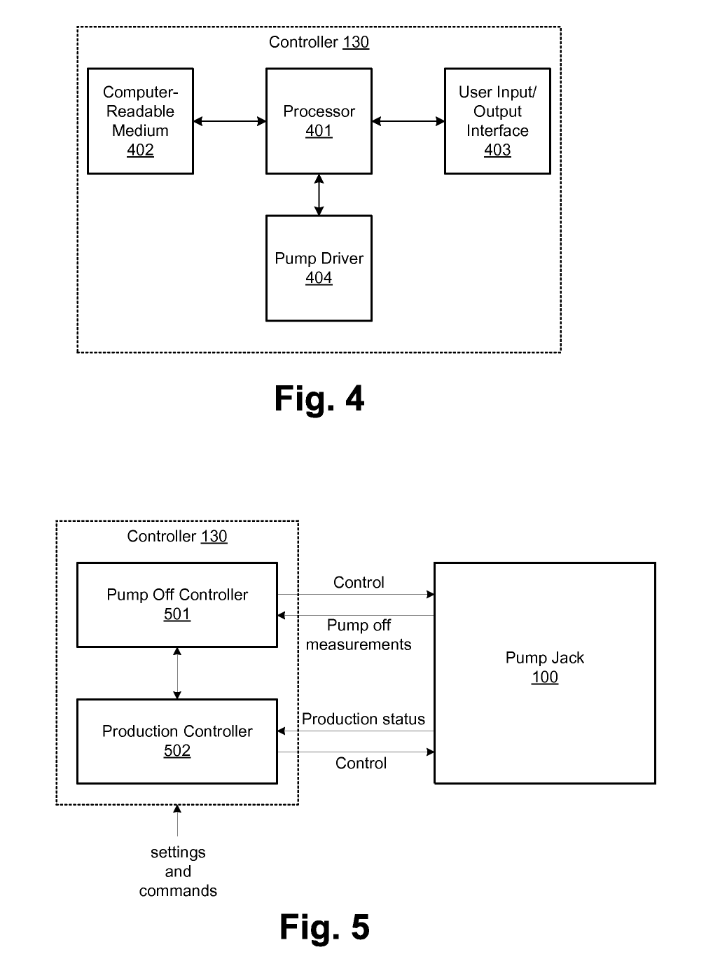

Any of the functions and steps described herein may be performed and/or controlled by controller 130. An example block diagram of controller 130 is shown in FIG. 4. Controller 130 may be or otherwise include a computer, and may include hardware that is hard-wired to perform specific functions and/or hardware that may execute software to perform specific functions. The software, if any, may be stored on a non-transitory computer-readable medium 402 in the form of computer-readable instructions. Controller 130 may read those computer-readable instructions, and in response perform various steps as defined by those computer-readable instructions. Thus, any functionality and/or steps performed by the controller 130 may be implemented, for example, by reading and executing such computer-readable instructions for performing such steps and implementing such functionality, and/or by any hardware subsystem (for example, a processor 401) from which controller 130 is composed. Processor 401 may be implemented as, for example, a central processing unit (CPU), an application-specific integrated circuit (ASIC), a field-programmable to gate array (FPGA), and/or a programmable logic controller (PLC). Additionally or alternatively, any of the above-mentioned functions may be implemented by the hardware of controller 130, with or without the execution of software.

Computer-readable medium 402 may include not only a single physical non-transitory storage medium or single type of such medium, but also a combination of one or more such storage media and/or types of such media. Examples of computer-readable medium 402 include, but are not limited to, one or more memory chips, hard drives, optical discs (such as CDs or DVDs), magnetic discs, and magnetic tape drives. Computer-readable medium 402 may be physically part of, or otherwise accessible by, controller 130, and may store computer-readable instructions (for example, software) and/or computer-readable data (i.e., information that may or may not be executable).

Controller 130 may also include a user input/output interface 403 for receiving input from a user (for example, via a keyboard, mouse, and/or remote control) and/or for providing output to the user (for example, via display device, an audio speaker, and/or a printer). For example, user input/output interface 403 may be used to indicate pump ON or OFF status, time remaining until pump ON or OFF, pump fill, and/or any other desired information.

Controller 130 may further include a pump driver 404 for controlling whether prime mover 105 will operate to cause pumping action. For example, pump driver 404 may cause prime mover 105 to turn on and off as desired. In some embodiments, controller 130, via pump driver 404, may cause prime mover 105 to turn on or off, or otherwise adjust its operation, such as changing the speed of the pump (changing the stroke speed). As will be discussed, such pump control operations may be performed in response to a pump off condition and/or another factor such as the expiration of a timer and/or based on gas production rate.

FIG. 5 is another block diagram of an example controller, including a pump off controller 501 and a production controller 502. Pump off controller 501 and production controller 502 may be physically separate units, or they may be integrated as a single controller with the functionality of both controllers 501, 502. For example, controller 130 may implement one or both of pump off controller 501 and production controller 502. In some embodiments, pump off controller 501 and production controller 502 may utilize the same physical processor 401, but may be implemented using different portions of the above-mentioned computer-executable instructions. In other embodiments, pump off controller 501 and production controller 502 may utilize different physical processors and/or other hardware, and may communicate with each other in a wired and/or wireless manner. In either case, if production controller 501 is already in operation in the field, rather than replace the entire controller 301, production controller 502 may be retrofitted with production controller 502, such as via a software upgrade to controller 103 and/or as a hardware addition to controller 103.

Pump off controller 501 may be configured to control the ON and OFF states of pump jack system 100 in response to one or more measurements relevant to a pump off condition, and/or responsive to the expiration of a timer. For instance, pump off controller 501 may be configured to turn the pump ON until either a pump off condition is detected or a timeout occurs, whichever occurs first. Examples of measurements that may be relevant to a pump off condition include, as discussed previously, torque and/or force measurements.

Production controller 502 may be configured to modify the operation of the pump based on actual production measurements. This may be done in various ways. For example, production controller 502 may provide an input to pump off controller 501, which may cause pump off controller 501 to modify how it controls the pump. Alternatively, production controller 502 may directly control the pump. In the latter case, commands from pump off controller 501 and production controller 502 to the pump may be arbitrated in the event of conflicting commands. For example, a command to turn or maintain the pump OFF by either of the controllers 501, 502 may take precedence over a command to turn or maintain the pump ON. Or, a command to turn or maintain the pump ON by either of the controllers 501, 502 may take precedence over a command to turn or maintain the pump OFF.

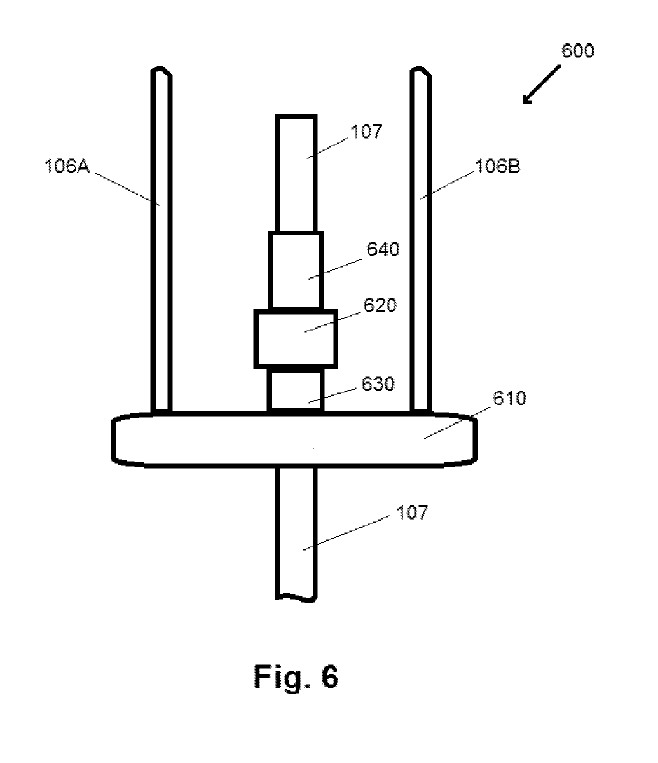

An arrangement of a force sensor is illustrated in FIG. 6. Illustrated in FIG. 6 is the upper portion of the polished rod 107 of a pumpjack system such as is illustrated in FIG. 1. The string (or birdie) 106, illustrated in FIG. 6 as two cables to 106A and 106B, is secured to a carrier bar 610 through which the polished rod passes. Above the carrier bar, the polished rod passes through a load cell 620 which is disposed between a washer 630 and a polished rod clamp 640. An example of a load cell which may be utilized is the Stainless Steel Polished Rod Load Cell available from Weatherford Production Optimization (Kingwood, Texas). The polished rod clamp is fixedly secured to the polished rod. Downward force exerted on the polished rod and/or upward force applied by the string causes a compressive force to be exerted on the load cell 620 which translates the applied force into a signal, for example, an electrical signal, which may be provided to the controller 130.

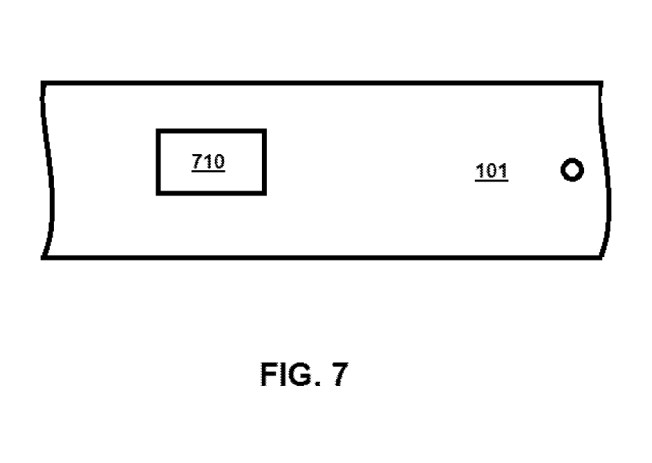

In another embodiment, illustrated in FIG. 7, a strain gauge 710 may be coupled to a portion of the walking beam 101. Vertical force exerted by or to the polished rod results in a flexing of the walking beam and compressive or expansive force applied to the strain gauge. The force experienced by the strain gauge is correlated with the force exerted on or by the polished rod. The strain gauge translates the experienced force into a signal, for example, an electrical signal, which may be provided to the controller 130.

One or more position sensors may be provided at one or more locations on the pumpjack. For example, an accelerometer (not shown) may be secured to any reciprocating part of the pumpjack, for example, the carrier bar, polished rod, or horse head to detect vertical displacement of the polished rod. Alternatively or additionally an attitude, level, or tilt sensor may be positioned on the walking beam to detect an angle of the walking beam relative to horizontal, which may be translated into a position in the stroke cycle of the polished rod. The accelerometer, attitude, level, or tilt sensor(s) may be any mechanical or electrical form of such sensors known in the art. For example, the accelerometer or level sensor may be a micromechanical (MEMS) sensor, an optical sensor, or a magnetic sensor and the present disclosure is not limited to any particular form of sensor. Examples of sensors which may be utilized include the DPS™ (Dual Position Sensor) or the Oil Field Inclinometer, both available from Weatherford Production Optimization (Kingwood, Texas). Other examples include spring-reel sensors where a wire is spooled out/in to detect the stroke or a global positioning system (GPS) sensor that has altitude measurement capability.

The load cell(s), strain gauge(s), and/or position sensor(s) (collectively, the “pumpjack sensors”) are typically electrically connected by wires to a telemetry or data communication module which in turn provides output data from the pumpjack sensors to signal conditioning hardware or analog input hardware, again typically through a wired connection. The signal conditioning hardware or analog input hardware provides conditioned signals through a wired connection to a programmable logic controller (PLC) or other data processing apparatus, typically located in the controller 130, to execute control over the operation of the pump responsive to receiving the signals from the pumpjack sensors.

There are various improvements that may be made to the pumpjack sensor(s) and control systems as described above. The wiring between the various components, for example, the pumpjack sensors and the data communication module, between the data communication module and the signal conditioning hardware or analog input hardware, between the signal conditioning hardware or analog input hardware and the controller, and power wires to each respective component may break or become detached during use or accidentally during maintenance performed on the pumpjack by a maintenance technician. The various electrical wires, for example, the power wires, may also pose a risk of electric shock to maintenance workers.

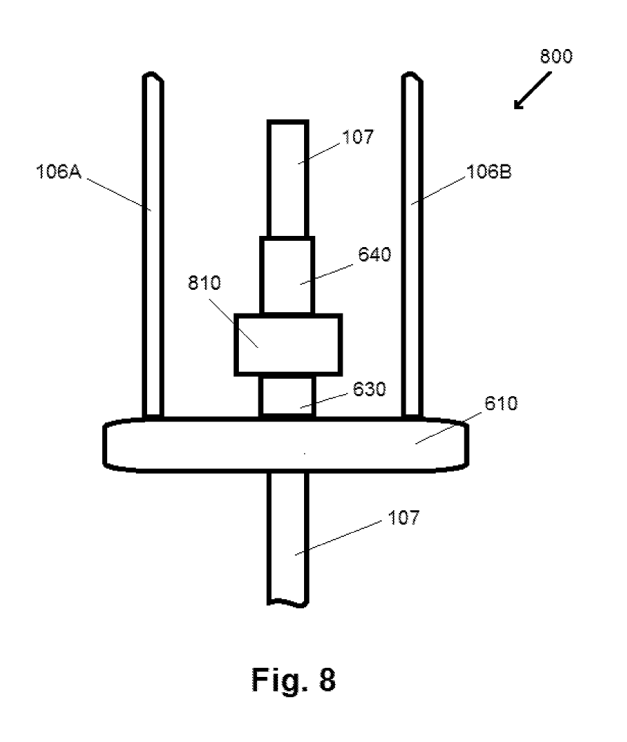

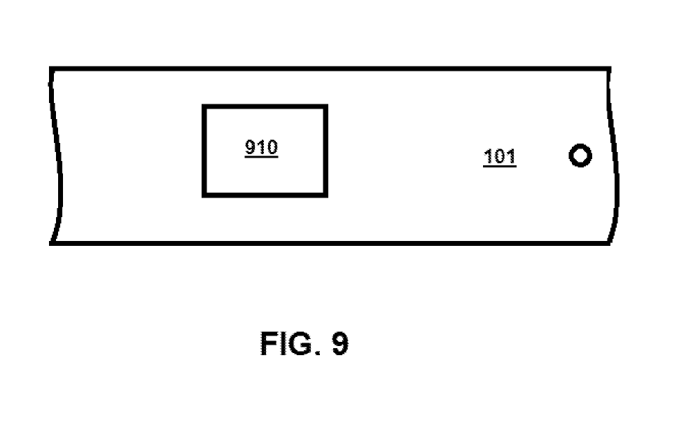

It has been discovered that it is possible to integrate multiple traditionally separate components of a pumpjack sensor and control system together in a single package. This package could include, for example, any one or more of a load cell, position sensor, sensor signal conditioner, a PLC or other data processing apparatus and associated memory, a data transmitter, and a power supply. An example of such an integrated sensor and control component package may be located where the load cell is typically located on the polished rod, for example, as illustrated at 810 in the system indicated generally at 800 in FIG. 8. Additionally or alternatively, an integrated sensor and control component package including a strain gauge could be positioned on the walking beam as illustrated at 910 in FIG. 9.

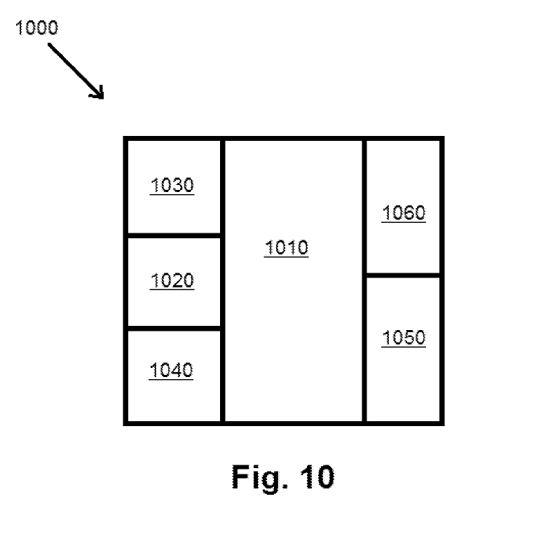

An example of an integrated sensor and control component package is illustrated generally at 1000 in FIG. 10. The integrated sensor and control component to package includes a load cell 1010 (and/or strain gauge), a position sensor 1020, a signal conditioner 1030 for one or both of the load cell and position sensor (or a separate signal conditioner for each of the load cell and position sensor), a data processor 1040, for example, a PLC and associated memory, a power supply 1050, and a data transmitter 1060 for transmitting control signals to the controller 130 or prime mover 105. An analog to digital converter may be included in any one or more of the components of the integrated sensor and control component package to convert analog signals from the pumpjack sensors into digital signals which may be more easily processed by, for example, the data processor 1040. The control signals transmitted to the controller 130 or prime mover 105 may be selected based on one or more signals provided by the load cell 1010 (and/or strain gauge), one or more signals provided by the position sensor 1020, or by a combination of signals provided by the load cell 1010 (and/or strain gauge), and the position sensor 1020.

In some embodiments one or more of the components of the integrated sensor and control component package 1000 of FIG. 10 may be absent or replaced by alternative components.

In some embodiments, the data transmitter 1060 is electrically coupled to the controller 130 or prime mover 105 by a wired connection. In other embodiments, the data transmitter 1060 communicates with the controller 130 or prime mover 105 wirelessly.

The provision of multiple components of a pumpjack sensor and control system together in a single integrated sensor and control component package reduces the amount of wires that could be broken or which could pose safety concerns, especially if the integrated sensor and control component package communicates wirelessly with the controller 130 or prime mover 105.

In some embodiments, calculations which might otherwise be performed by a PLC or other apparatus located in the controller 130 are performed by the data processor 1040 in the integrated sensor and control component package 1000. This has the advantage of reducing the amount of information that is transmitted to the controller 130. Instead of providing sensor data from, for example, signal conditioning hardware or analog input hardware to the PLC or other apparatus located in the controller 130 for analysis, most or all required calculations are performed within the integrated sensor and control component package 1000. The integrated sensor and control component package 1000 then transmits a minimal amount of data, for example, signals to start, stop, or adjust the speed of the pumpjack to the controller 130 or directly to the prime mover 105. In some embodiments, only commands to start, stop, or to adjust the stroke speed, continuous stroke duration, stroke frequency, and/or delay between stroke cycles are communicated from the integrated sensor and control component package to the controller 130 or directly to the prime mover 105. In some embodiments sensor data from the pumpjack sensors is not communicated from the integrated sensor and control component package. In other embodiments, in addition to the commands to start, stop, or to adjust the stroke speed, continuous stroke duration, stroke frequency, and/or delay between stroke cycles, the integrated sensor and control component package 1000 also transmits, and in some embodiments, receives other data, for example, data regarding a value and/or trending of one or more internal controller variables, which is in some embodiments captured, for example, on a server in communication with the pumpjack controller for analysis. A non-exhaustive list of examples of internal controller variables which, in some embodiments, are transmitted, and in some embodiments, are received by the integrated sensor and control component package 1000 include one or more of geometry variables of the pumpjack, settings for how often to change pump speeds, pump off times and modes, control mode and/or readout variables including one or more of fluid production estimates, system loading variables, force and position values that may be used, for example, to produce graphs of force versus position which may be examined, power values calculated from the force and position variables, and pump fill values.

In some embodiments the reduction in the data transmitted reduces the power requirements of the pumpjack sensor and control system as compared to systems where any one or more of the various components (for example, the pumpjack sensors, telemetry or data communication module, signal conditioning hardware or analog input hardware, and PLC or other data processing apparatus) are provided as discreet units in separate packages and/or locations on the pumpjack.

In some embodiments, the power supply 1050 may comprise a battery. The low amount of data that is transmitted from the integrated sensor and control component package 1000 extends the life of the battery as compared with other systems which require the transmission of a greater amount of data. The extension of the life of the battery reduces the need for maintenance to replace the battery. In some embodiments, the battery may be recharged by an electrical power connection from a source of power to the pumpjack. In other embodiments, the battery may be recharged by a charging system integrated into or coupled to the integrated sensor and control component package 1000. For example, in some embodiments, the integrated sensor and control component package 1000 is provided with one or more solar cells to provide energy to charge the battery. Additionally or alternatively, the integrated sensor and control component package 1000 could include or be coupled to an apparatus capable of generating electrical power from the kinetic energy associated with movement of the pumpjack. Such an energy generating apparatus may include, for example, a piezoelectric transducer, a device including a magnet which moves past a coil of wire with the motion of the pumpjack to generate electricity, a kinetic energy capture device such as found in many self-winding watches which includes an output connected to a miniature electric generator to produce energy to charge the battery, or device including reservoir of fluid which is compressed and decompressed upon movement of the pumpjack to move the fluid through a generator, for example, a generator having a rotor which is rotated by the moving fluid relative to a stator, or a substrate which utilizes the principle of reverse electrowetting to generate electricity as the fluid is passed through it.

In other embodiments, a pumpjack including one or more separate sensor and/or control components may be retrofitted with an integrated sensor and control component package as described herein. In some embodiments, the controller 130 or prime mover 105 of the retrofitted pumpjack may be provided with a wireless receiver for wirelessly receiving data from the data transmitter of the integrated sensor and control component package.

Having thus described several aspects of at least one embodiment, it is to be to appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An integrated sensor and control component package for control of a pumpjack comprising:
a force sensor contained in a package;
a position sensor contained in the package; and
a data transmitter contained in the package and coupled to the force sensor and the position sensor and configured to transmit control signals for the pumpjack to one of a controller and a prime mover of the pumpjack.

2. The integrated sensor and control component package of claim 1, further comprising a signal conditioner contained in the package, the signal conditioner coupled to one of the force sensor and the position sensor and configured to process a signal from one of the force sensor and the position sensor.

3. The integrated sensor and control component package of claim 2, further comprising a data processor contained in the package, the data processor coupled to the signal conditioner and the data transmitter and configured to receive and process data from the signal conditioner and to provide an output signal to the data transmitter.

4. The integrated sensor and control component package of claim 3, further comprising a power source contained in the package, the power source coupled to one or more of the force sensor, position sensor, signal conditioner, data processor, and data transmitter and configured to supply power to one or more of the force sensor, position sensor, signal conditioner, data processor, and data transmitter.

5. The integrated sensor and control component package of claim 4, wherein the power source is configured to convert kinetic energy to electrical energy.

6. The integrated sensor and control component package of claim 4, wherein the power source comprises a battery.

7. The integrated sensor and control component package of claim 1, wherein the data transmitter is configured to communicate wirelessly with the one of the controller and the prime mover of the pumpjack

8. The integrated sensor and control component package of claim 1, wherein the data transmitter is configured to communicate commands to the one of the controller to and the prime mover to one or more of stop the pumpjack, start the pumpjack, and adjust a pumping speed of the pumpjack.

9. The integrated sensor and control component package of claim 1, wherein the force sensor comprises a load cell.

10. The integrated sensor and control component package of claim 1, wherein the force sensor comprises a strain gauge.

11. A method of controlling a pumpjack including a walking beam, polished rod, and a controller, the method comprising:
generating a force signal indicative of a force applied to the polished rod with a force sensor contained in a package;
generating a position signal indicative of a position of the polished rod with a position sensor contained in the package;
generating a control signal for the pumpjack responsive to a value of one of the force signal and the position signal; and
transmitting the control signal to the controller from a data transmitter contained in the package.

12. The method of claim 11, further comprising processing one of the force signal and the position signal with a signal conditioner contained in the package prior to generating the control signal for the pumpjack.

13. The method of claim 12, wherein generating the control signal comprises processing one of the force signal and the position signal with a data processor contained in the package.

14. The method of claim 11, further comprising supplying power to one or more to of the force sensor, position sensor, signal conditioner, data processor, and data transmitter from a power source contained in the package.

15. The method of claim 11, wherein generating the control signal for the pumpjack comprises generating the control signal responsive to a combination of the value of the force signal and the value of the position signal.

16. The method of claim 11, wherein transmitting the control signal to the controller from the data transmitter comprises wirelessly transmitting the control signal to the controller from the data transmitter.

17. The method of claim 11, wherein transmitting the control signal to the controller from the data transmitter comprises transmitting a signal commanding the controller to one of stop the pumpjack, start the pumpjack, and adjust a pumping speed of the pumpjack.

18. The method of claim 11, wherein generating the force signal comprises generating a signal indicative of a compressive force applied to a load cell coupled to the polished rod.

19. The method of claim 11, wherein generating the force signal comprises generating a signal indicative of a degree of flexure of the walking beam.

20. A method of retrofitting a pumpjack comprising:
providing the pumpjack with an integrated sensor and control component package including:
a force sensor contained in a package;
a position sensor contained in the package; and
a data transmitter contained in the package and coupled to the force sensor and the position sensor and configured to transmit control signals for the pumpjack to one of a controller and a prime mover of the pumpjack.
